(19) United States
(12) Patent Application Publication
(10) Pub. No.: US 2017/0257796 A1
(43) Pub. Date: Sep. 7, 2017

(54) Selective Uplink Only Header Compression Mechanism

(71) Applicant: MEDIATEK INC., Hsinchu (TW)

(72) Inventor: Chia-Chun Hsu, New Taipei City (TW)

(21) Appl. No.: 15/493,390

(22) Filed: Apr. 21, 2017

Related U.S. Application Data
(60) Provisional application No. 62/304,393, filed on Mar. 7, 2016.

(51) Int. Cl. H04W 28/06; H04W 28/02

(52) U.S. Cl. CPC H04W 28/06; H04W 28/0289; H04W 76/02

(57) ABSTRACT

A method of selective uplink-only robust header compression (ROHC) mechanism is proposed. The ROHC channel comprises two unidirectional channels, i.e., there is one channel for the downlink and one for the uplink. To solve the uplink resource shortage, ROHC is activated and applied on selective packets of selective uplink flow. Once ROHC configuration is provided by a serving base station, a user equipment (UE) can select certain UL packets to apply ROHC based on a list of conditions. By activating ROHC for UL only and performing ROHC selectively, the compression efficiency can be improved with less UE power consumption and computation complexity.

### CROSS REFERENCE TO RELATED APPLICATIONS

This application claims priority under 35 U.S.C. §119 from U.S. Provisional Application No. 62/304,393, entitled “Selective Uplink Only Header Compression Mechanism,” filed on Mar. 7, 2016, the subject matter of which is incorporated herein by reference.

### TECHNICAL FIELD

The disclosed embodiments relate generally to compression mechanism in mobile communication network, and, more particularly, to selective uplink only header compression mechanism.

### BACKGROUND

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipments (UEs) over established radio resource control (RRC) connections and data radio bearers (DRBs). The radio access network further connects with a core network (CN), which includes Mobility Management Entity (MME), Serving Gateway (S-GW), and Packet Data Network Gateway (P-GW), to provide end-to-end services. In the downlink (DL), traffic flows from an application server, through the core network, through a serving base station, and to a UE. In the uplink (UL), traffic flows from the UE, through its serving base station, through the core network, and to the application server.

Historically, downlink was considered to be the bottleneck of a mobile network. Based on the statistics, the ratio of DL vs. UL is typical 9 to 1, e.g. HTTP video/audio, web browsing. Therefore, DL capacity improvement was usually the focus of system design. However, with the latest trend, the shortage of uplink resource becomes more and more concern in the network because of following factors: 1) The high uplink traffic ratio for social networking. This is because users not only focused on viewing existing content, but also actively contribute to creating content. Examples include uploading posts, pictures and videos. In other words, social networking application makes more and more mobile internet users becoming content producers. 2) The proliferation of online storage services (such as Google Drive and iCloud) increase UL traffic volumes. Again, user generates more contents and upload from their mobile device. 3) P2P TV and P2P file sharing move from PC to mobile device. Statistics show that the highest ratio of uplink traffic volume for P2P file sharing in one network can reach as high as 50%. 4) While DL capacity can be increased by carrier aggregation (CA), the increased UL traffic can typically only use a single UL carrier. This is because that UE usually operates with fewer uplink carriers, i.e. typically only one. This is to balance UE battery consumption and complexity. 5) In 3GPP standard, device-to-device (D2D) transmission, i.e. Sidelink transmission, also consumes UL resources. If D2D becomes popular, this will also result in the reduction of available uplink resources for no-D2D transmission. Furthermore, dynamic UL/DL configuration is not common for TDD-LTE network due to its complexity. Typically, most TDD-LTE networks still use UL/DL configuration #2, i.e. DL:UL=3:1. Therefore, it is quite often that uplink becomes the bottleneck in some cells in case of heavy content uploading. Based on these trends, there is an urgent need to improve uplink capacity for mobile networks.

In streaming application, the overhead of IP, UDP, and RTP is 40 bytes for IPv4, and 60 bytes for IPv6. For voice over IP (VoIP), this corresponds to 60% of the total amount of data sent. Such large overheads are excessive for LTE networks where bandwidth is scarce. Robust header compression (ROHC) is a standardized method to compress the IP, UDP, RTP, and TCP headers of Internet packets. ROHC compresses these 40 bytes or 60 bytes of overhead typically into only one or three bytes, by placing a compressor before the link that has limited capacity, and a decompressor after that link. The compressor converts the large overhead to onlly a few bytes, while the decompressor does the opposite.

The ROHC channel comprises two unidirectional channels, i.e., there is one channel for the downlink and one for the uplink. In LTE, there is one set of parameters signaled to UE, and the same values shall be used for both channels belonging to the same PDCP entity, i.e. same ROHC profile to compress/decompress UL/DL data. Furthermore, once ROHC is configured, it applies to all DL/UL packets. A more flexible mechanism is sought to solve the shortage of uplink resource.

### SUMMARY

A method of selective uplink-only robust header compression (ROHC) mechanism is proposed. The ROHC channel comprises two unidirectional channels, i.e., there is one channel for the downlink and one for the uplink. To solve the uplink resource shortage, ROHC is activated and applied on selective packets of selective uplink flow. Once ROHC configuration is provided by a serving base station, a user equipment (UE) can select certain UL packets to apply ROHC based on a list of conditions. By activating ROHC for UL only and performing ROHC selectively, the compression efficiency can be improved with less UE power consumption and computation complexity.

In one embodiment, a user equipment (UE) establishes a radio resource control (RRC) connection and a packet data network (PDN) connection with a serving base station in a mobile communication network. The UE receives an RRC reconfiguration to configure an uplink-only robust header compression (ROHC) mechanism for IP packets from the UE over the PDN connection. The UE determines whether an IP packet is applicable for applying ROHC based on a list of conditions. The UE transmits the IP packet to the base station. The IP packet comprises a field indicating whether the IP packet header is compressed or not.

In another embodiment, a base station establishes a radio resource control (RRC) connection and a packet data network (PDN) connection with a UE in a mobile communication network. The base station transmits an RRC reconfiguration to configure an uplink-only robust header compression (ROHC) mechanism for IP packets from the UE over the PDN connection. The base station receives an IP packet from the UE. The base station performs header decompression when a field of the IP packet indicates the IP packet header is compressed.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network with selective uplink-only robust header compression (ROHC) mechanism in accordance with one novel aspect.

FIG. 2 is a simplified block diagram of a UE and an eNodeB that carry out certain embodiments of the present invention.

FIG. 3 illustrates a PDCP layer functional view between a transmitting PDCP entity and a receiving PDCP entity with ROHC mechanism.

FIG. 4 illustrates the concept of selective UL only ROHC for different IP traffic flows in accordance with one novel aspect.

FIG. 5 illustrates a first embodiment of a signaling flow for selective UL only ROHC in accordance with one novel aspect.

FIG. 5A illustrates one example of a list of supported ROHC profiles.

FIG. 5B illustrates one example of performance result for Zlib-based UDC and UL ROHC.

FIG. 6 illustrates a second embodiment of a signaling flow for selective UL only ROHC in accordance with one novel aspect.

FIG. 7 is a flow chart of a method of selective uplink-only ROHC mechanism from UE perspective in accordance with one novel aspect.

FIG. 8 is a flow chart of a method of selective uplink-only ROHC mechanism from eNB perspective in accordance with one novel aspect.

### DETAILED DESCRIPTION

Reference will now be made in detail to some embodiments of the invention, examples of which are illustrated in the accompanying drawings.

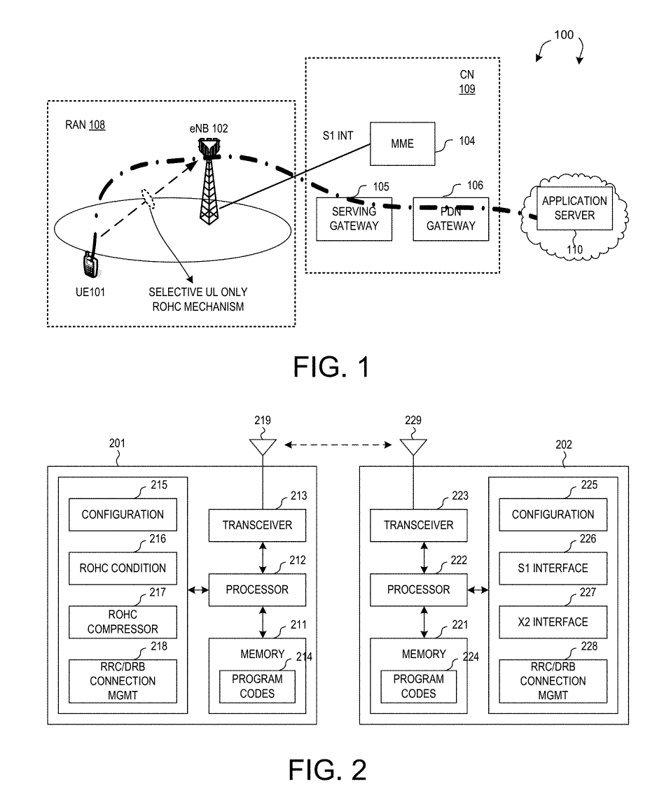

FIG. 1 illustrates a mobile communication network 100 with selective uplink-only robust header compression (ROHC) mechanism in accordance with one novel aspect. Mobile communication network 100 comprises a user equipment UE 101, a radio access network (RAN) 108 having a base station eNB 102, and a packet core network (CN) 109 having a mobility management entity MME 104, a serving gateway SGW 105, a packet data network (PDN) gateway PGW 106, and an application server 110 or the Internet. The base stations communicate with each other via the X2 interface (not shown), and eNB 102 communicates with MME 104 via the S1 interface. UE 101 can access application server 110 through the radio access network RAN 108 and the packet core network CN 109.

In order to perform data transmission over an established connection with the application server, UE 101 first establishes a radio resource control (RRC) connection with signaling radio bearer (SRB) to access RAN 108, and also establishes a packet data network (PDN) connection with data radio bearer (DRB) to access CN 109. For downlink, IP traffic flows from application server 110, through CN 109, through RAN 108, to UE 101. For uplink, IP traffic flows from UE 101, through RAN 108, through CN 109, to application server 110. Lossy data compression is common for applications like image JPEG, video MPEG to improve transmission efficiency. However, it is not guaranteed that every application would compress all of the data it generates. In fact, most of applications do not compress data, since complexity might be the concern. Furthermore, even if a single file compression is done, there is more opportunity to compress multiple packets together, and more redundancy can be found to further decrease the size of UL data. In conclusion, it is difficult to force each application to compress its own data, and it makes sense to assign the task to Packet Data Convergence Protocol (PDCP) layer, where all UL data go through before on air.

Robust header compression (ROHC) is a standardized method to compress the IP, UDP, RTP, and TCP headers of Internet packets. The ROHC channel comprises two unidirectional channels, i.e., there is one channel for the downlink and one for the uplink. In LTE, there is one set of parameters signaled to UE, and the same values shall be used for both channels belonging to the same PDCP entity, i.e. same ROHC profile to compress/decompress UL/DL data. Furthermore, once ROHC is configured, it applies to all DL/UL packets. With the latest trend, the shortage of uplink resource becomes more and more concern in the network. A more flexible mechanism is sought to solve the shortage of uplink resource. In accordance with one novel aspect, ROHC is activated and applied on selective packets of selective UL flow. In the example of FIG. 1, UE 101 receives RRC reconfiguration from eNB 102 to activate and configure for UL only ROHC mechanism. Once the ROHC configuration is provided, UE 101 can select UL packets to apply ROHC.

FIG. 2 is a simplified block diagram of a user equipment UE 201 and a base station eNodeB 202 that carry out certain embodiments of the present invention. User equipment UE 201 comprises memory 211 having program codes and data 214, a processor 212, a transceiver 213 coupled to an antenna module 219. RF transceiver module 213, coupled with the antenna, receives RF signals from the antenna, converts them to baseband signals and sends them to processor 212. RF transceiver 213 also converts received baseband signals from the processor, converts them to RF signals, and sends out to antenna 219. Processor 212 processes the received baseband signals and invokes different functional modules and circuits to perform different features and embodiments in UE 201. Memory 211 stores program instructions and data 214 to control the operations of UE 201.

User equipment UE 201 also comprises various function circuits and modules including a configuration circuit 215 that determines ROHC triggering condition and obtains ROHC configuration, an ROHC condition detecting circuit 216 that determines a list of conditions for applying selective UL-only ROHC, an ROHC compressor 217 that performs header compression for selected IP flows and IP packets, and an RRC/DRB connection management and handling circuit 218 that performs RRC connection setup procedure and NAS setup procedure. The different circuits and modules are function circuits and modules that can be configured and implemented by software, firmware, hardware, or any combination thereof. The function modules, when executed by the processors (e.g., via executing program codes 214 and 224), allow UE 201 and eNB 202 to perform enhanced network entry signaling and procedure. In one example, UE 201 indicates to eNB 202 to activate selective UL only ROHC, receives ROHC configuration from eNB 202, and performs ROHC on selected uplink IP flows and uplink IP packets accordingly.

Similarly, base station eNodeB 202 comprises memory 221 having program codes and data 224, a processor 222, a transceiver 223 coupled to an antenna module 229. RF transceiver module 223, coupled with the antenna, receives RF signals from the antenna, converts them to baseband signals and sends them to processor 222. RF transceiver 223 also converts received baseband signals from the processor, converts them to RF signals, and sends out to antenna 229. Processor 222 processes the received baseband signals and invokes different functional modules and circuits to perform different features and embodiments in eNodeB 202. Memory 221 stores program instructions and data 224 to control the operations of eNodeB 202. Base station eNodeB 202 also comprises various function circuits and modules including a configuration module 225 that provides ROHC configuration to UE 201, an S1 interface module 226 that manages communication with an MME in the core network, an X2 interface module 227 that manages communication with other base stations, and an RRC/DRB connection management and handling circuit 228 that performs RRC connection setup and NAS setup procedures and maintains RRC/DRB connection.

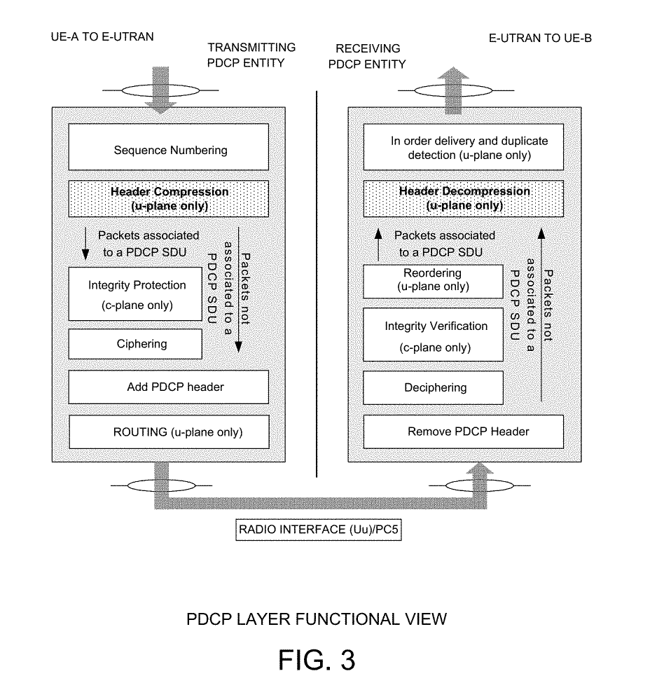

FIG. 3 illustrates a PDCP layer functional view between a transmitting PDCP entity and a receiving PDCP entity with ROHC mechanism. In LTE, there is one set of parameters signaled to UE, and the same values shall be used for both channels belonging to the same PDCP entity, i.e. same ROHC profile to compress/decompress UL/DL data. Furthermore, once ROHC is configured, it applies to all DL/UL packets. However, with selective UL only ROHC, ROHC is activated and applied on selective UL IP packets of selective UL IP flow. In the example of FIG. 3, UE-A is the transmitting PDCP entity for UL traffic, and UE-B is the receiving PDCP entity for DL traffic. For UL IP flow, UE-A performs sequence numbering, ROHC header compression. For each IP packet associated to a PDCP SDU, UE-A performs integrity protection, Ciphering, adds PDCP header, performs routing, and passes to the radio interface. For each packet not associated to a PDCP SDU, UE-A adds PDCP header, performs routing, and passes to the radio interface. The IP packet is then transmitted over the air interface. For DL IP flow, UE-B receives the IP packet from the radio interface, removes PDCP header. For each IP packet associated to a PDCP SDU, UE-B performs Deciphering, integrity verification, reordering, ROHC header de-compression, and in-order delivery and duplicate detection to upper layer and APP layer. For each IP packet not associated to a PDCP SDU, UE-B performs header ROHC de-compression, and in-order delivery and duplicate detection to upper layer and APP layer.

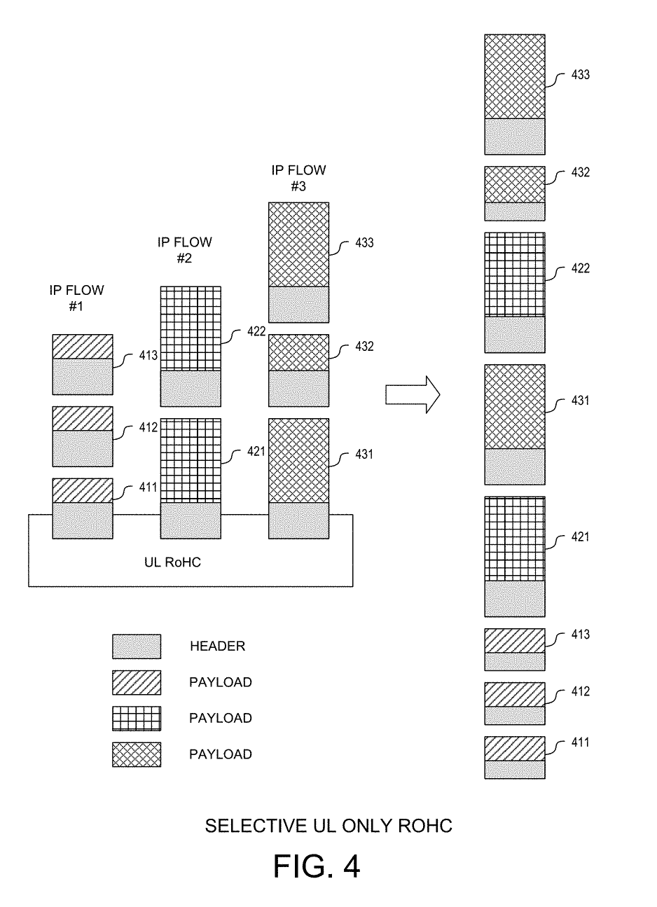

FIG. 4 illustrates the concept of selective UL only ROHC for different IP traffic flows in accordance with one novel aspect. In the example of FIG. 4, three IP flows, IP flow #1, IP flow #2, and IP flow #3 are multiplexed over a single data radio bearer (DRB) of a UE. The UE performs selective UL only ROHC header compression on some packets of two of the three IP flows. For example, for IP flow #1, all the IP packets 411, 412, and 413 are applied with ROHC. For IP flow #2, neither of the IP packets 421 and 422 are applied with ROHC. For IP flow #3, IP packet 432 is applied with ROHC, while IP packets 431 and 432 are not applied with ROHC. The UE can select the IP flows and the IP packets to apply ROHC based on a list of conditions.

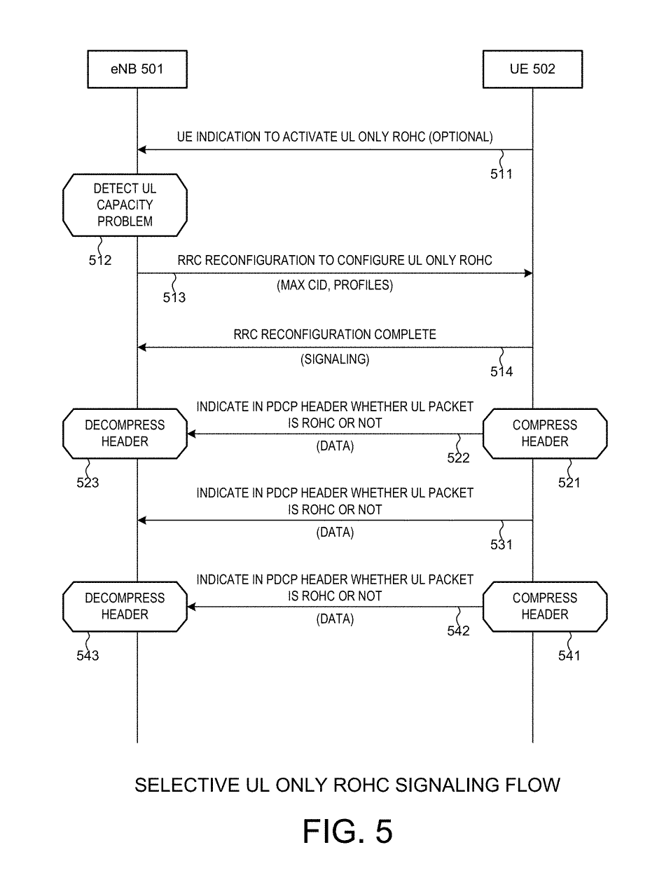

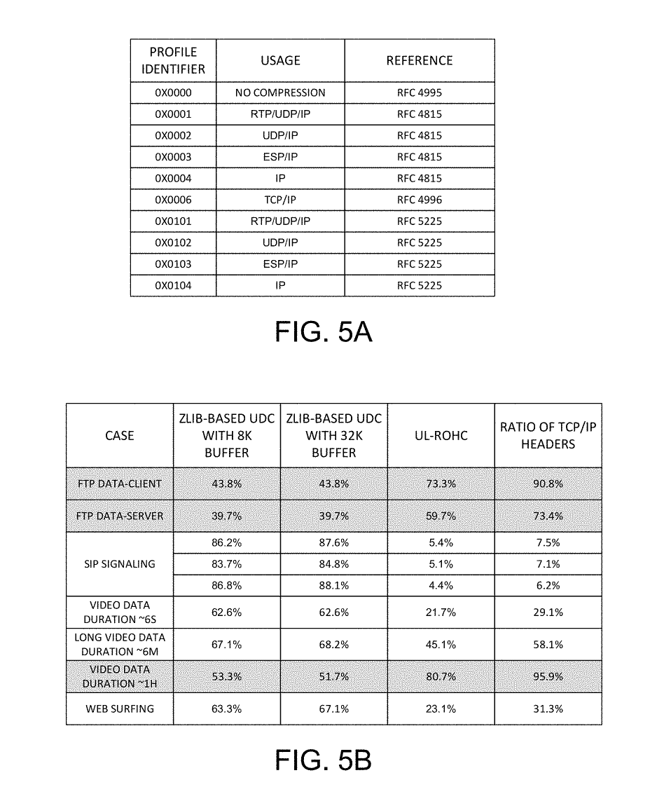

FIG. 5 illustrates a first embodiment of a signaling flow for selective UL only ROHC in accordance with one novel aspect. In step 511, UE 502 sends an indication to eNB 501 to activate UL only ROHC mechanism. This step is optional, and UE 502 may send such indication based on certain triggering conditions, e.g., detecting uplink capacity problem. In step 512, eNB 501 detects uplink capacity problem either on its own or based from the UE indication, eNB 501 then determines to activate the UL only ROHC mechanism. In step 513, eNB 501 sends an RRC reconfiguration message, e.g., a new information element (IE) to configure the UL only ROHC. The ROHC configuration may include a maximum connection ID (CID) and at least one ROHC profile. Maximum CID indicates the maximum number of flows that the ROHC entity can handle. One CID value shall always be reserved for uncompressed flows. Profiles indicates which profiles are allowed to be used by the UE. FIG. 5A illustrates one example of a list of supported ROHC profiles. In step 514, UE 502 sends an RRC reconfiguration complete message back to eNB 501 upon receiving the ROHC configuration.

Once the ROHC configuration is provided, UE 502 can select certain UL IP packets to apply ROHC. For example, ROHC is applied on with voice traffic due the significant overhead of each voice packet. On the other hand, since the header part of a non-voice packet is relatively not big, ROHC may not be applied for non-voice traffic. For TCP traffic, while the DL packet is big and DL ROHC is not necessary, the UL response packet (such as TCP ACK), the header overhead is also big. As a result, those UL packets should be selected for UL-only ROHC. In general, the selection is based on a list of conditions, which may be comprised by one or more of the following. First, ROHC can be applied to IP packets with certain service, e.g. TCP/IP headers. For example, downlink video FTP or other type of download. This type of traffic usually has huge DL packet, but only small UL packets, e.g. TCP ACK. Second, ROHC can be applied to IP packets that the packet size is below certain threshold, e.g. total packet size is smaller than around 70 bytes for IPv6. Third, ROHC can be applied to IP packets that the packet header and packet payload ratio is above certain threshold around 70%. Fourth, ROHC can be applied to IP packets with compressed payload. UE can then use a field in the PDCP header to indicate whether packet header is compressed or not for each IP packet. For example, the ROHC UL packets are tagged. FIG. 5B illustrates one example of performance result for Zlib-based UDC and UL ROHC. It can be seen that UL ROHC delivers much better performance when ratio of TCP/IP headers is higher than 70%.

In step 521, UE 502 performs header compression on IP packet #1, and indicates in PDCP header that the UL packet is applied with ROHC. In step 522, UE 502 transmits the IP packet #1 to eNB 501. In step 523, eNB 501 receives the IP packet #1 and performs header de-compression. In step 531, UE 502 transmits IP packet #2 to eNB 501 without performing header compression, and eNB 501 does not need to perform header de-compression. In step 541, UE 502 performs header compression on IP packet #3, and indicates in PDCP header that the UL packet is applied with ROHC. In step 542, UE 502 transmits the IP packet #3 to eNB 501. In step 543, eNB 501 receives the IP packet #3 and performs header de-compression accordingly.

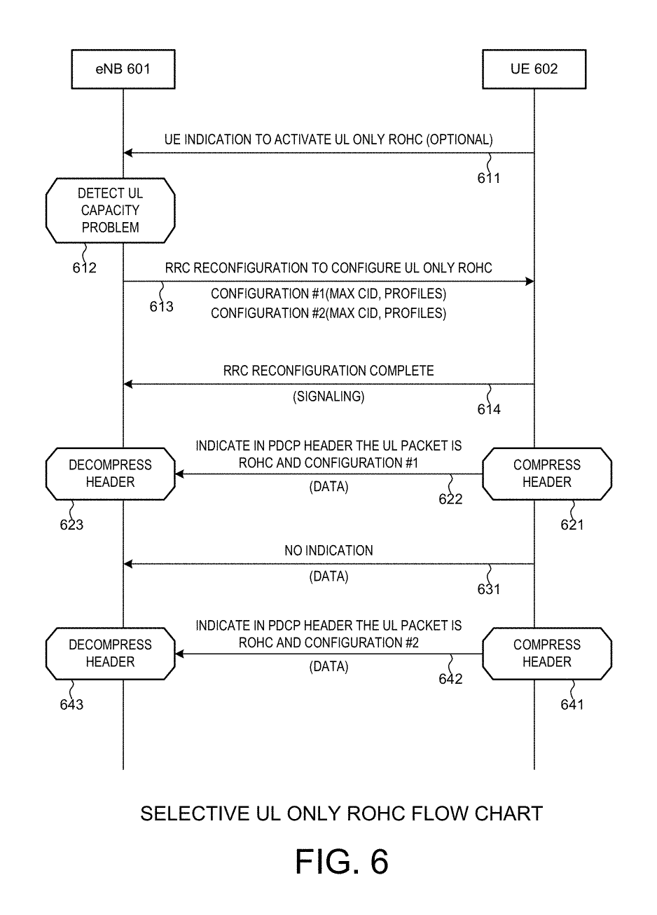

FIG. 6 illustrates a second embodiment of a signaling flow for selective UL only ROHC in accordance with one novel aspect. Multiple IP flows can be multiplexed on a single radio bearer. Multiple ROHC threads can be used in parallel to compress the header of the different IP flows. The same ROHC configuration can be used for each ROHC thread, or different ROHC configurations can be used for different ROHC threads. In step 611, UE 602 sends an indication to eNB 601 to activate UL only ROHC mechanism. This step is optional, and UE 602 may send such indication based on certain triggering conditions, e.g., detecting uplink capacity problem. In step 612, eNB 601 detects uplink capacity problem either on its own or based from the UE indication, eNB 601 then determines to activate the UL only ROHC mechanism. In step 613, eNB 601 sends an RRC reconfiguration message, e.g., a new information element (IE) to configure the UL only ROHC with multiple ROHC configurations, to be applied on different IP flows. For example, IP flow #1 is applied with ROHC configuration #1, and IP flow #2 is applied with ROHC configuration #2. Each ROHC configuration may include a maximum CID and a ROHC profile. In step 614, UE 602 sends an RRC reconfiguration complete message back to eNB 601 upon receiving the ROHC configuration.

Once the ROHC configuration is provided, UE 602 can select certain UL IP flows and/or IP packets to apply ROHC. The selection is based on a list of conditions, which may be comprised by one or more of the following. First, ROHC can be applied to IP flows and/or packets with certain TCP/IP headers. Second, ROHC can be applied to IP flows and/or packets that the packet size is below certain threshold. Third, ROHC can be applied to IP flows and/or packets that the packet header and packet payload ratio is above certain threshold. Fourth, ROHC can be applied to IP flows and/or packets with compressed payload. UE can then use a field in the PDCP header to indicate whether packet header is compressed or not for each IP packet. For example, the ROHC UL packets are tagged.

In step 621, UE 602 performs header compression on IP packet #1 of IP flow #1 using ROHC configuration #1, and indicates in PDCP header that the UL packet is applied with ROHC. In step 622, UE 602 transmits the IP packet #1 to eNB 601. In step 623, eNB 601 receives the IP packet #1 and performs header de-compression. In step 631, UE 602 transmits IP packet #2 to eNB 601 without performing header compression, and eNB 601 does not need to perform header de-compression. In step 641, UE 602 performs header compression on IP packet #3 of IP flow #2 using ROHC configuration #2, and indicates in PDCP header that the UL packet is applied with ROHC. In step 642, UE 602 transmits the IP packet #3 to eNB 601. In step 643, eNB 601 receives the IP packet #3 and performs header de-compression accordingly.

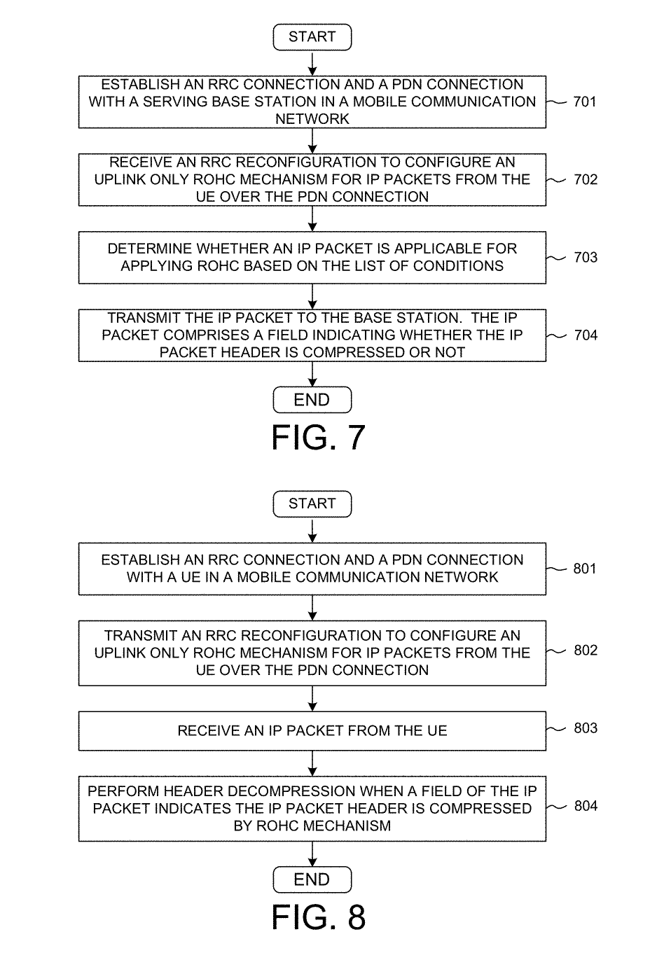

FIG. 7 is a flow chart of a method of selective uplink-only ROHC mechanism from UE perspective in accordance with one novel aspect. In step 701, a UE establishes a radio resource control (RRC) connection and a packet data network (PDN) connection with a serving base station in a mobile communication network. In step 702, the UE receives an RRC reconfiguration to configure an uplink-only robust header compression (ROHC) mechanism for IP packets from the UE over the PDN connection. In step 703, the UE determines whether an IP packet is applicable for applying ROHC based on a list of conditions. In step 704, the UE transmits the IP packet to the base station. The IP packet comprises a field indicating whether the IP packet header is compressed or not.

FIG. 8 is a flow chart of a method of selective uplink-only ROHC mechanism from eNB perspective in accordance with one novel aspect. In step 801, a base station establishes a radio resource control (RRC) connection and a packet data network (PDN) connection with a user equipment (UE) in a mobile communication network. In step 802, the base station transmits an RRC reconfiguration to configure an uplink-only robust header compression (ROHC) mechanism for IP packets from the UE over the PDN connection. In step 803, the base station receives an IP packet from the UE. In step 804, the base station performs header decompression when a field of the IP packet indicates the IP packet header is compressed by ROHC mechanism.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
establishing a radio resource control (RRC) connection and a packet data network (PDN) connection by a user equipment (UE) with a serving base station in a mobile communication network;
receiving an RRC reconfiguration to configure an uplink-only robust header compression (ROHC) mechanism for IP packets from the UE over the PDN connection;
determining whether an IP packet is applicable for applying ROHC based on a list of conditions; and
transmitting the IP packet to the base station, wherein the IP packet comprises a field indicating whether the IP packet header is compressed or not.

2. The method of claim 1, wherein the RRC reconfiguration comprises a ROHC configuration including a maximum connection ID (CID) and at least one ROHC profile.

3. The method of claim 2, wherein multiple IP flows are multiplexed on the PDN connection, wherein the multiple IP flows are applied with the same ROHC configuration.

4. The method of claim 2, wherein multiple IP flows are multiplexed on the PDN connection, wherein the multiple IP flows are applied with different ROHC configurations.

5. The method of claim 1, wherein the list of conditions comprises at least one of an IP header type, a packet size smaller than a first threshold, a ratio between a header and a payload larger than a second threshold, and a packet with a compressed payload.

6. The method of claim 1, further comprising:
determining a triggering condition for uplink-only ROHC; and
transmitting an indication to the base station to activate the uplink-only ROHC mechanism.

7. The method of claim 6, wherein the triggering condition comprises an uplink capacity problem.

8. A user equipment (UE), comprising:
a connection handling circuit that establishes a radio resource control (RRC) connection and a packet data network (PDN) connection by a user equipment (UE) with a base station in a mobile communication network;
a radio frequency (RF) receiver that receives an RRC reconfiguration to configure an uplink-only robust header compression (ROHC) mechanism for IP packets from the UE over the PDN connection;
an ROHC compression circuit that determines whether an IP packet is applicable for applying ROHC based on a list of conditions; and
an RF transmitter that transmits the IP packet to the base station, wherein the IP packet comprises a field indicating whether the IP packet header is compressed or not.

9. The UE of claim 8, wherein the RRC reconfiguration comprises a ROHC configuration including a maximum connection ID (CID) and at least one ROHC profile.

10. The UE of claim 9, wherein multiple IP flows are multiplexed on the PDN connection, wherein the multiple IP flows are applied with the same ROHC configuration.

11. The UE of claim 9, wherein multiple IP flows are multiplexed on the PDN connection, wherein the multiple IP flows are applied with different ROHC configurations.

12. The UE of claim 8, wherein the list of conditions comprises at least one of an IP header type, a packet size smaller than a first threshold, a ratio between a header and a payload larger than a second threshold, and a packet with a compressed payload.

13. The UE of claim 8, wherein the UE determines a triggering condition for uplink-only ROHC, and then transmits an indication to the base station to activate the uplink-only ROHC mechanism.

14. The UE of claim 13, wherein the triggering condition comprises an uplink capacity problem.

15. A method, comprising:
establishing a radio resource control (RRC) connection and a packet data network (PDN) connection by a base station with a user equipment (UE) in a mobile communication network;
transmitting an RRC reconfiguration to configure an uplink-only robust header compression (ROHC) mechanism for IP packets from the UE over the PDN connection;
receiving an IP packet from the UE; and
performing header decompression when a field of the IP packet indicates the IP packet header is compressed.

16. The method of claim 15, wherein the RRC reconfiguration comprises a ROHC configuration including a maximum connection ID (CID) and at least one ROHC profile.

17. The method of claim 16, wherein multiple IP flows are multiplexed on the PDN connection, wherein the multiple IP flows are applied with the same ROHC configuration.

18. The method of claim 16, wherein multiple IP flows are multiplexed on the PDN connection, wherein the multiple IP flows are applied with different ROHC configurations.

19. The method of claim 15, further comprising:
determining a triggering condition for activating the uplink-only ROHC mechanism, wherein the triggering condition comprises an uplink capacity problem.

20. The method of claim 15, further comprising:
receiving an indication from the UE to activate the uplink-only ROHC mechanism.
